(19) United States
(12) Patent Application Publication
(10) Pub. No.: US 2022/0069606 A1
(43) Pub. Date: Mar. 3, 2022

(54) Power Source

(71) Applicant: Tommie C. Tubbs, Newnan, GA (US)

(72) Inventor: Tommie C. Tubbs, Newnan, GA (US)

(21) Appl. No.: 17/004,627

(22) Filed: Aug. 27, 2020

(51) Int. Cl. H02J 7/00; H02J 7/14

(52) U.S. Cl. CPC H02J 7/0071; H02J 2207/20; H02J 7/14

(57) ABSTRACT

A power source including a timer operational between an off position where the power source is off and an on position where the power source is on and delivering power, a transformer electrically communicative with the timer, a contactor electrically communicative with the transformer, operational between an open configuration and a closed configuration, and controllable by the timer, a motor electrically communicative with the contactor, an alternator mechanically communicative with the motor, a fuse assembly configured to fail upon reaching a preset failure mode, a battery assembly configured to be rechargeable by the alternator, a junction block electrically communicative with the fuse assembly and through which the alternator is communicative with the battery assembly, and a converter system configured to convert charge from the battery assembly from DC-to-AC.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### SEQUENCE LISTING

Not Applicable

### STATEMENT REGARDING PRIOR DISCLOSURES BY THE INVENTOR OR A JOINT INVENTOR

Not Applicable

### BACKGROUND OF THE DISCLOSURE

### 1. Field of the Disclosure

The various exemplary embodiments of the disclosure relate generally to processes, methods, and systems for providing power.

### 2. Background

The first electromagnetic generator, the Faraday disk, was invented in 1831 by a British scientist named Michael Faraday. In the world of constant need to generate power to serve as means to convert motive power (mechanical energy) into electrical power, that same device known as a generator, has been used for many years. While a generator is effective, convenient, and is an alternate device used by millions of people every day, its source of power depends on gas, water, wind, solar, oil, or electric power for use in an external circuit.

Nearly 200 years following Faraday's invention, an improvement is needed to achieve and exceed the same power as the generator, but in a different

All electrical backup power systems operate on gas, oil, water, wind, electricity or oil that is stored or solar. Most often, in a power outage, these are also things that are difficult to access during inclement weather, natural disasters, or catastrophic crises. In third world countries, these things are also virtually unavailable.

### BRIEF SUMMARY OF THE DISCLOSURE

The various exemplary embodiments of the disclosure relate generally to processes, methods, and systems for power supply.

In an exemplary embodiment, the present invention is gas and oil free, pollution free, and virtually noise free. It is designed to create its own power source flow of electricity at 120V and it is self-sufficient simply by flipping a switch on. It will take care of itself, providing everyday use of electricity. A 12V DC pulley motor or 120V pulley motor turns alternator to charge batteries to ensure they are always ready for machine use.

A 300 A alternator is used to charge batteries. A junction block locates wiring from the alternator to the batteries. A 12V, 900 A lithium battery is used to supply 12V DC to the converter. The present device includes 6500 Watt DC-to-AC converters used to convert DC-to-AC power. A 120V timer runs for 20 minutes on and off for seven minutes in an exemplary embodiment, but can be set according to the application used, i.e., for car, home, construction, military practices, medical facilities, home medical use, following natural disasters, or as energy supply for third world countries.

A 120V/24V transformer is used to close the contactor when using a 12V DC pulley motor. A 24V 2-pole contactor normally opens, but when closed by the timer, 12V from the batteries pass through the contactor to the 12V DC pulley motor.

In another exemplary embodiment, the present invention is a gas and oil free, pollution free, and virtually noise free system, method and device. It is designed to create its own power source flow of electricity at 120V and is self-sufficient simply by flipping a switch on. It produces its power source by using two 900 A, 12V DC batteries. The batteries connect to two 12V DC-to-AC converters that changes DC into AC. After current has been converted, it powers up a 120V timer that allows a 12V DC or 120V motor to turn a 300 A alternator to keep batteries charged to feed the DC to converters.

The timer is set to energize a 120V/24V contactor that allows the motor that drives the fan belt to the alternator to charge batteries at 15 minutes run time and seven minutes down time. This allows the batteries to keep a full charge to ensure the present invention does not fail to put out 120V to 240V during the time it is in use. This timer will be set to the operation the invention is used for.

If the present invention is used for home back power, it can be stored, and a charger may be applied to the batteries until a power outage and activated by using a transfer switch. It will automatically start running and charge itself. The charge will be set to turn on every 72 hours for 20 minutes. This application is specifically designed because it requires no battery charges when not in use, but needs to stay hot until it is needed to perform its duty.

The present invention is useful where there is limited or no electricity, (water- or gas-powered sources), such as third world countries and where natural gas is not available. It can also be used by electrical vehicle designers, manufacturers and owners to travel without stopping to ever charge, medical facilities to supply vital power for medical services and medical machines; military (training, exercises & missions); aircrafts; live emergencies and disaster preparedness, essential Federal Agencies (i.e., Center for Disease Control (CDC), NASA and Homeland Security, technology, agricultural and human services' industries; and, or for everyday home purposes.

These and other objects, features and advantages of the present disclosure will become more apparent upon reading the following specification in conjunction with the accompanying description, claims and drawings.

### BRIEF DESCRIPTION OF THE DRAWINGS

The accompanying Figures, which are incorporated in and constitute a part of this specification, illustrate several aspects described below.

FIG. 1 is a process flow chart in accordance with an exemplary embodiment of the present disclosure.

FIG. 2 is another process flow chart in accordance with an exemplary embodiment of the present disclosure.

### DETAILED DESCRIPTION OF THE DISCLOSURE

Although preferred exemplary embodiments of the disclosure are explained in detail, it is to be understood that other exemplary embodiments are contemplated. Accordingly, it is not intended that the disclosure is limited in its scope to the details of construction and arrangement of components set forth in the following description or illustrated in the drawings. The disclosure is capable of other exemplary embodiments and of being practiced or carried out in various ways. Also, in describing the preferred exemplary embodiments, specific terminology will be resorted to for the sake of clarity.

As used in the specification and the appended claims, the singular forms “a,” “an” and “the” include plural referents unless the context clearly dictates otherwise.

Also, in describing the preferred exemplary embodiments, terminology will be resorted to for the sake of clarity. It is intended that each term contemplates its broadest meaning as understood by those skilled in the art and includes all technical equivalents which operate in a similar manner to accomplish a similar purpose.

Ranges can be expressed herein as from “about” or “approximately” one particular value and/or to “about” or “approximately” another particular value. When such a range is expressed, another exemplary embodiment includes from the one particular value and/or to the other particular value.

Using “comprising” or “including” or like terms means that at least the named compound, element, particle, or method step is present in the composition or article or method, but does not exclude the presence of other compounds, materials, particles, method steps, even if the other such compounds, material, particles, method steps have the same function as what is named.

Mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

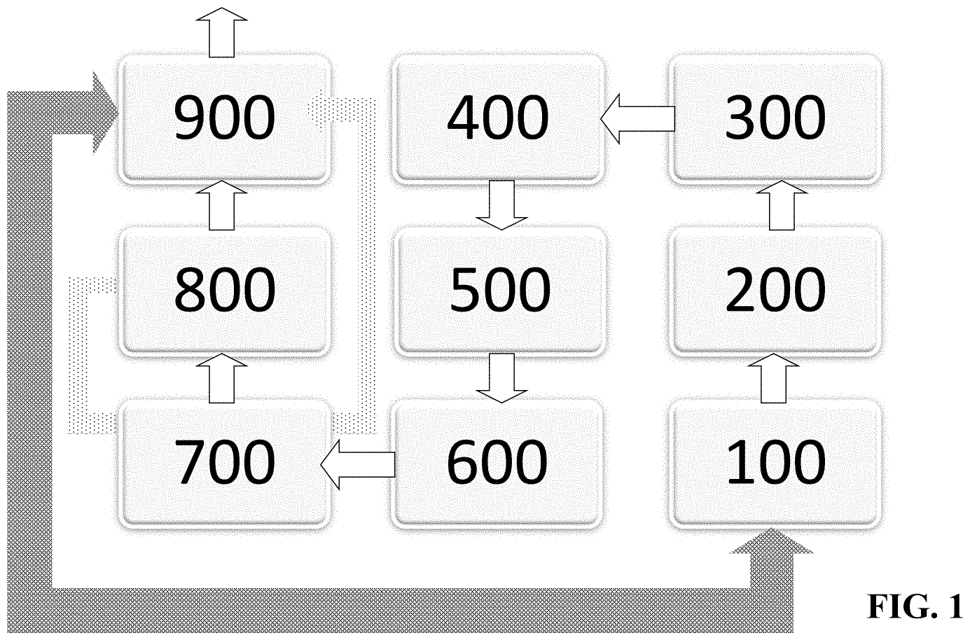

As shown FIG. 1, the present invention comprises timer 100, transformer 200, contactor 300, motor 400, alternator 500, junction block 600, fuse assembly 700, battery assembly 800, and converter system 900.

Timer 100 operates with a control mechanism that dictates on and off modes. They can be great energy savers, enhance the life of power sources, and increases safety. In an exemplary embodiment, the timer 100 is a 120-Volt (V) timer that runs “on” for 20 minutes, and is “off” for seven minutes. The timer 100 can be set as needed, for example, to charge a vehicle, for use in a home, a construction site, military practices, medical facilities, home medical use, natural disaster relief, and as an energy supply in locations otherwise devoid of established energy supplies.

The mechanism of the timer 100 may be mechanical, electromechanical (e.g., a slowly rotating geared motor that mechanically operates switches) or electronic, with semiconductor timing circuitry and switching devices and no moving parts. The timer 100 switches the present equipment on, off, or both, at a preset time or times, after a preset interval, or cyclically. A countdown time switch switches power, usually off, after a preset time. A cyclical timer switches equipment both on and off at preset times over a period, then repeats the cycle; the period is usually 24 hours or seven days.

The timer 100 is electrically communicative with transformer 200. As is well known, an ideal transformer is a theoretical linear transformer that is lossless and perfectly coupled. Perfect coupling implies infinitely high core magnetic permeability and winding inductances and zero net magnetomotive force. A varying current in the transformer's primary winding attempts to create a varying magnetic flux in the transformer core, which is also encircled by the secondary winding. This varying flux at the secondary winding induces a varying electromotive force (EMF, voltage) in the secondary winding due to electromagnetic induction and the secondary current so produced creates a flux equal and opposite to that produced by the primary winding, in accordance with Lenz's law.

The windings are wound around a core of infinitely high magnetic permeability so that all of the magnetic flux passes through both the primary and secondary windings. With a voltage source connected to the primary winding and a load connected to the secondary winding, the transformer currents flow in the indicated directions and the core magnetomotive force cancels to zero. According to Faraday's law, since the same magnetic flux passes through both the primary and secondary windings in an ideal transformer, a voltage is induced in each winding proportional to its number of windings. The transformer winding voltage ratio is directly proportional to the winding turns ratio.

Transformer 200 deviates from the ideal transformer. The ideal transformer model neglects the following basic linear aspects of real transformers: (a) core losses, collectively called magnetizing current losses, consisting of: hysteresis losses due to nonlinear magnetic effects in the transformer core, and Eddy current losses due to joule heating in the core that are proportional to the square of the transformer's applied voltage; (b) unlike the ideal model, the windings in a real transformer have non-zero resistances and inductances associated with: Joule losses due to resistance in the primary and secondary windings, and leakage flux that escapes from the core and passes through one winding only resulting in primary and secondary reactive impedance; and (c) similar to an inductor, parasitic capacitance and self-resonance phenomenon due to the electric field distribution.

In an exemplary embodiment, transformer 200 comprises a 120V/24V used to close the contactor 300 when using motor 400. As disclosed, there are many sizes, shapes and configurations of transformers that range from very small to exceptionally large such as those that are used in power transmission. Some are made with stubbed out wires, screw or spade terminals, and others are made mounting in PC boards, others for being screwed or bolted down.

Transformer 200 can comprise are composed of a laminated iron core with one or more windings of wire, which transforms voltage and current from one level to another. An alternating current (AC) flowing through one coil of wire, the primary, induces a voltage in one or more other coils of wire, the secondary coils. It is the changing voltage of AC that induces voltage in the other coils through the changing magnetic field. Direct current (DC) such as from a battery or DC power supply will not work in a transformer. Only AC makes a transformer work. The magnetic field flows through the iron core. The faster the voltage changes, the higher the frequency.

The transformer 200 is electrically communicative with contactor 300. A contactor is an electrically controlled switch used for switching an electrical power circuit. A contactor is typically controlled by a circuit which has a much lower power level than the switched circuit, such as a 24V coil electromagnet controlling a 230V motor switch. Unlike general-purpose relays, contactors are designed to be directly connected to high-current load devices. Relays tend to be of lower capacity and are usually designed for both normally closed and normally open applications. Devices switching more than 15 amperes (A) or in circuits rated more than a few kilowatts are usually called contactors. Apart from optional auxiliary low-current contacts, contactors are almost exclusively fitted with normally open contacts. Unlike relays, contactors are designed with features to control and suppress the arc produced when interrupting heavy motor currents.

Contactors come in many forms with varying capacities and features. Unlike a circuit breaker, a contactor is not intended to interrupt a short circuit current. Contactors range from those having a breaking current of several amperes to thousands of amperes and 24V DC to many kilovolts. The physical size of contactors ranges from a device small enough to pick up with one hand, to large devices approximately a meter (yard) on a side. Contactors are used to control electric motors, lighting, heating, capacitor banks, thermal evaporators, and other electrical loads.

In an exemplary embodiment, contactor 300 comprises a 24V 2-pole contactor. A contactor comes in either a single, double or triple pole. Contactor 300 is designed with a double pole. It is normally opened, but when closed by the transformer 200, 12V from battery assembly 800 passes through the contactor 300 to the motor 400. When 24V are sent to the contactor 300, a coil in the contactor 300 creates a magnetic field that pulls it closed and sends power to the to the motor 400. The contactor 300 is controlled by the transformer 200 which is controlled by the timer 100 which will turn the motor on and off.

The contactor 300 is electrically communicative with motor 400. In an exemplary embodiment, motor 400 is one of a 12V DC pulley motor and a 120V pulley motor that turns the alternator 500 to charge battery assembly 800 to ensure one or more batteries of the battery assembly 800 are always ready for machine use.

A DC motor is a fairly simple electric motor that uses electricity and a magnetic field to produce torque, which causes it to turn. A DC pulley motor is a type of DC motor with a pulley that is affixed to a DC pulley motor to guide a tension belt or serpentine belt that turns the alternator 500. The type motor pulley can vary according to its purpose. In an exemplary embodiment, motor 400 operates at 3500 rpm.

The motor 400 is preferably mechanically communicative (via belts) with alternator 500. In an exemplary embodiment, the present alternator 500 is a 300 A alternator to charge one or more batteries of the battery assembly 800. The alternator is used to make sure the battery assembly 800 stays fully charged and that everything connected to an electrical system will remain with power.

An alternator is a generator of electrical power and most often used as part of a charging system. An alternator has three main components (stator, rotor, and diode) and a voltage regulator. When attaching the motor 400 belt to the alternator 500 pulley, the belt spins the pulley on the alternator's rotary shaft. When the pulley belt of the motor 400 is attached to a pulley of an alternator, (or a serpentine belt), it turns the alternator at preferably 3500 rpm which allows the alternator to output sufficient amperage to keep one or more batteries of the battery assembly 800 charged.

The stator is attached and fixed to the case of the alternator and does not move or turn. The rotor is a moving component of an electromagnetic system in the alternator. Its rotation is due to the interaction between the windings and magnet fields which produces a torque around the rotor's axis. The magnetic field of the rotor sweeps through the stator windings producing electrical current in the alternator. Because of the rotation of the rotor, AC is produced. The diode is an electronic device within the alternator that allows electrical current to flow in one direction only. Diodes are used to convert AC into DC.

When using a 12V DC pulley motor 400, 12V should hit the contactor 300 primary side from the junction block 600 using 12V fuse protection (from fuse assembly 700) and a 120V AC pulley motor 400 will feed directly from the timer 100 load side. A 120V motor 400 may not need a transformer or a contactor and be wired directly from the timer 100.

The alternator 500 is electrically communicative with junction block 600. The junction block 600 is essentially a location for wiring from the alternator 500 to the battery assembly 800 or where connected. The junction block 600 serves as and is essential for providing the main point for all wiring of the present invention. It is enclosed to protect two or more wires carrying electrical current.

The junction block 600 is electrically communicative with fuse assembly 700. In an exemplary embodiment, the fuse assembly 700 includes a 12V DC fuse block for this use. Fuses will automatically blow in case of short circuit in positive lead going to the battery assembly 800. At times, some electrical parts fail. If a part fails suddenly, there is typically a short burst of energy fed back into the electrical system. A fuse of the fuse assembly 700 protects most electrical components from feedback; however, the alternator 500 is not typically protected by a fused circuit. Since the diodes will only allow electrical current to flow in one direction, the energy feedback travels as far as the diodes, but not into the alternator 500 itself. The alternator will then be isolated from any energy returns which can damage the alternator. A 120V AC fuse would automatically blow once the current reaches 80% of its full current amperage value.

The fuse assembly 700 is electrically communicative with both the battery assembly 800 and converter system 900. The battery assembly 800 is also electrically communicative with junction block 600.

In an exemplary embodiment of the battery assembly 800, two 12V DC, 900 A lithium batteries are used to supply 12V DC current to the converter system 900. The lithium batteries comprise lithium metal chemistries of various types of cathodes and electrolytes, but all with lithium as the anode. In an exemplary embodiment, each battery requires 0.15 to 0.3 kilogram (kg) of lithium per kilowatt-hour (kWh).

The battery assembly 800 is electrically communicative with fuse assembly 700. In an exemplary embodiment, the fuse assembly 700 further includes a second 12V DC fuse block to divide the electrical power feed into subsidiary circuits, while providing a protective fuse or circuit breaker for each circuit, in a common enclosure.

Fuse assembly 700 interrupts excessive current (blows) so that further damage by overheating or fire is prevented. Wiring regulations often define a maximum fuse current rating for particular circuits. Overcurrent protection devices are essential in electrical systems to limit threats to human life and property damage. It is used here to protect the converter system 900.

The fuse assembly 700 is electrically communicative with converter system 900. In an exemplary embodiment, the converter system 900 comprises two 6500 watts DC-to-AC converters to convert DC-to-AC power. Direct current is a bit easier to understand than alternating current. Rather than oscillating back and forth, DC provides a constant voltage or current. DC can be generated in a number of ways: (1) An AC generator equipped with a device called a “commutator” can produce direct current; (2) Use of a device called a “rectifier” which converts AC to DC; and, (3) Batteries provide DC, which is generated from a chemical reaction inside of the battery. Alternating Current (AC): Alternating current describes the flow of charge that changes direction periodically. As a result, the voltage level also reverses along with the current. AC is used to deliver power to houses, office buildings, etc. Generating AC: AC can be produced using a device called an alternator. This device is a special type of electrical generator designed to produce alternating current.

Converting voltage to power measured in watts is easy using a simple Watt's Law formula. Watt's Law states that current is equal to power divided by voltage. Using a little algebra we can change this formula a bit to also state that power is equal to voltage times current. The formula to convert voltage to wattage is Power (W)=Voltage (V)×Current (A). Thus, to solve for wattage, one may simply multiply the voltage by the current in amps.

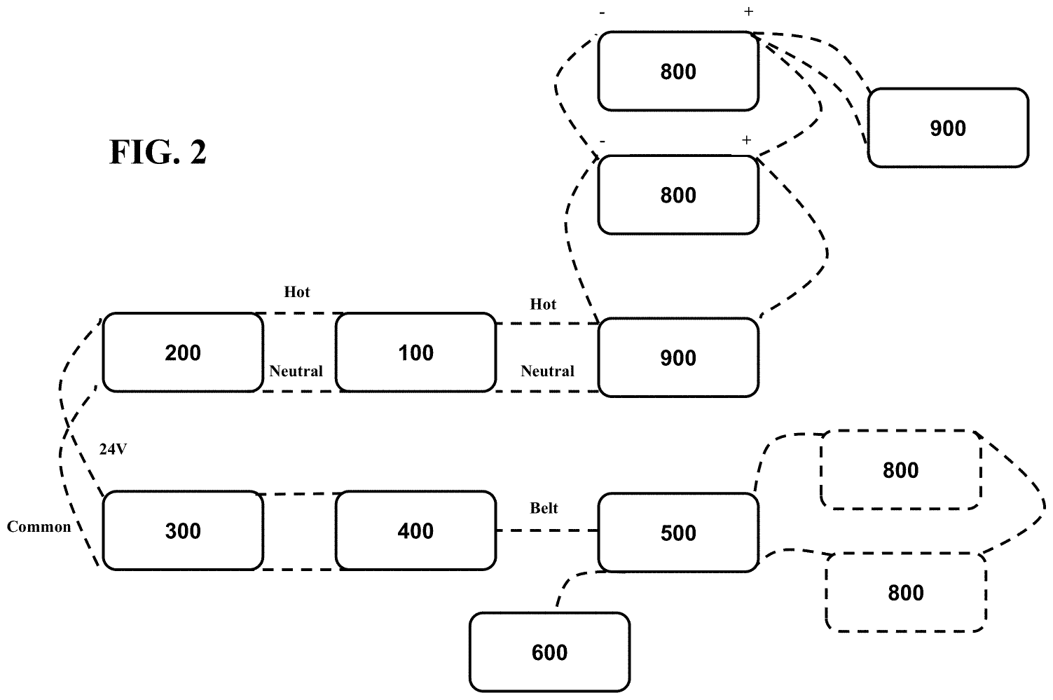

As shown FIG. 2, battery assembly 800 are the source of power, preferably 900 A lithium batteries. A 6000 W converter system 900 changes DC-to-AC. Converter system 900 manually switches are located on, for example, dashboard of electric cars. The converter system 900 also has an auto safety switch to protect the system. The 120V team 100 feeds from the converter system 900 and is set to go on and off at 20 minutes on, and seven minutes off. It could be adjusted and set at a greater or lesser time, depending on the purpose the system is being used for.

The 120V/24V transformer 200 feeds from the timer 100 to allow 12V DC to cross the contactor 300 or 120V to cross the contactor 300, whichever motor 400 is used, which can be fed across the contactor 300 that has a 24V pulling in windings. 24V normally open (N/O) feeds from the 120V/24V transformer 200 that pulls in the contactor 300 upon demand of the timer 100.

The motor 400 feeds from the contactor 300 once the transformer 200 signals the contactor 300 to pull in to the normally close (N/C) position. The 900 A alternator 500 is driven by a pulley belt from the motor 400 that preferably runs at 3600 rpm to turn the alternator 500 at adequate speed to keep the 900 A battery assembly 800 charged during use of the system. Alternator 500 feeds back to battery assembly 800 to keep the cycle running continuously without the system failing while in use. The junction block 600 is connected to the positive from alternator 500 to the battery assembly 800

It is to be understood that the exemplary embodiments and claims disclosed herein are not limited in their application to the details of construction and arrangement of the components set forth in the description and illustrated in the drawings. Rather, the description and the drawings provide examples of the exemplary embodiments envisioned. The exemplary embodiments and claims disclosed herein are further capable of other exemplary embodiments and of being practiced and carried out in various ways. Also, it is to be understood that the phraseology and terminology employed herein are for the purposes of description and should not be regarded as limiting the claims.

Accordingly, those skilled in the art will appreciate that the conception upon which the application and claims are based can be readily utilized as a basis for the design of other structures, methods, and systems for carrying out the several purposes of the exemplary embodiments and claims presented in this application. It is important, therefore, that the claims be regarded as including such equivalent constructions.

I claim:

1. A power source comprising:
a timer operational between an off position where the power source is off and an on position where the power source is on and delivering power;
a transformer electrically communicative with the timer
a contactor electrically communicative with the transformer, operational between an open configuration and a closed configuration, and controllable by the timer;
a motor electrically communicative with the contactor;
an alternator mechanically communicative with the motor;
a fuse assembly configured to fail upon reaching a preset failure mode;
a battery assembly configured to be rechargeable by the alternator;
a junction block through which the alternator is communicative with the battery assembly; and
a converter system configured to convert charge from the battery assembly from DC-to-AC.

2. The power source of claim 1, wherein the power source is configured to produce 120V; and
wherein the motor is selected from the group consisting of a 12V DC pulley motor and a 120V pulley motor.

3. The power source of claim 1, wherein the alternator is a 300 A alternator.

4. The power source of claim 1, wherein the battery assembly includes a 12V, 900 A lithium battery.

5. The power source of claim 1, wherein the converter system includes two 6500 Watt DC-to-AC converters.

6. The power source of claim 1, wherein the timer is a 120V timer configured to be in the off position for approximately seven minutes and the on position for approximately between 15-20 minutes.

7. The power source of claim 1, wherein the transformer is a 120V/24V transformer configured to close the contactor when the motor is a 12V DC pulley motor.

8. The power source of claim 1, wherein the contactor is a 24V 2-pole contactor.

9. A power source comprising:
a timer operational between an off position where the power source is off and an on position where the power source is on and delivering power;
a transformer electrically communicative with the timer;
a contactor electrically communicative with the transformer, operational between an open configuration and a closed configuration, and controllable by the timer;
a motor electrically communicative with the contactor;
an alternator mechanically communicative with the motor;
a fuse assembly configured to fail upon reaching a preset failure mode;
a battery assembly configured to be rechargeable by the alternator;
a junction block electrically communicative with the fuse assembly and through which the alternator is communicative with the battery assembly; and
a converter system configured to convert charge from the battery assembly from DC-to-AC;
wherein the fuse assembly is electrically communicative with both the battery assembly and the converter system; and
wherein the battery assembly is electrically communicative with junction block.
